(19) United States
(12) Patent Application Publication
(10) Pub. No.: US 2004/0246862 A1
(43) Pub. Date: Dec. 9, 2004

(54) Method and apparatus for signal discrimination

(76) Inventors: Nam-Ik Cho, Seoul (KR); Hyung-Il Koo, Seoul (KR); Jun-Won Choi, Seoul (KR)

Correspondence Address: HARNESS, DICKEY & PIERCE, P.L.C., P.O. BOX 8910, RESTON, VA, 20195, US

(21) Appl. No.: 10/740,542

(22) Filed: Dec. 22, 2003

(30) Foreign Application Priority Data
Jun. 9, 2003 (KR) 2003-36746

(51) Int. Cl. G11B 5/09

(52) U.S. Cl. 369/59.22; 369/124.07

(57) ABSTRACT

In a method and apparatus for discriminating a signal from one or more mixed signals, where the mixed signal may include two or more signal components, an interpreting unit generates a plurality of multiplication parameters based on a plurality of inputs that are related to a mixed signal. A finite impulse response (FIR) filter may output a removal-target signal based on the generated multiplication parameters. A subtracting unit may then generate an output signal representing a signal component of the mixed signal by subtracting the removal-target signal from a second signal.

### PRIORITY STATEMENT

This application claims the priority of Korean Patent Application No. 2003-36746, filed on Jun. 9, 2003, in the Korean Intellectual Property Office, the disclosure of which is hereby incorporated by reference in its entirety.

### BACKGROUND OF THE INVENTION

1. Field of the Invention

The present invention relates to a method and apparatus for signal discrimination.

2. Description of the Related Art

Song accompaniment devices or arrangements having karaoke functions have become widely used and popular, both in the home and at places of entertainment, for example. A song accompaniment apparatus or device includes a memory that stores a number of selectable accompaniment songs for play by a user. The number of accompaniment songs that may be played are thus inevitably limited by the memory's storage capacity, as well as by cost, for example.

In an acoustic signal such as a song that is output from a CD player, DVD player, cassette tape player or FM audio broadcast receiver, for example, the accompaniment melody signal and voice signal are mixed. When compact disc (CD) players, digital video disc (DVD) players, or cassette tape players respectively play a CD, a DVD, or audio cassette tape, the karaoke function may be implemented by removing a voice signal from the song, outputting only the melody signal (without voice). The karaoke function may also be implemented by removing the voice signal from an output of an FM audio broadcast, so that only the melody without voice is output.

Techniques for removing the voice signal from the acoustic signal are in the process of being developed. In a conventional approach to remove the voice signal from the acoustic signal, the acoustic signal is converted into a frequency domain signal, and a specific frequency band of the voice signal is removed from the frequency domain signal. A conventional method of converting the acoustic signal into the frequency domain signal may be achieved via a fast Fourier transform (FFT) or subband filtering, as described in U.S. Pat. No. 5,375,188 to Serikawa et al., entitled, “Music/voice Discriminating Apparatus”, for example.

However, since a frequency band (up to several kHz) of a voice signal includes an accompaniment melody signal component, a certain part of the accompaniment melody signal component is lost when the frequency band of the voice signal is removed. This results in a lower quality output accompaniment melody. In an effort to reduce this loss, a pitch of the voice signal is detected, and only a frequency in which the pitch of the voice signal is present is removed. However, due to the effect of the accompaniment melody signal, it is substantially difficult to detect the pitch of the voice signal, and present detection reliability of the pitch is relatively poor.

### SUMMARY OF THE INVENTION

Exemplary embodiments of the present invention are directed to a method and apparatus for discriminating a signal from one or more mixed signals, in which the mixed signal may include two or more signal components. In the method, an interpreting unit generates a plurality of multiplication parameters based on a plurality of inputs that are related to a mixed signal. A finite impulse response (FIR) filter may output a removal-target signal based on the generated multiplication parameters. A subtracting unit may then generate an output signal representing a signal component of the mixed signal by subtracting the removal-target signal from a second signal.

### BRIEF DESCRIPTION OF THE DRAWINGS

Exemplary embodiments of the present invention will become more fully understood from the detailed description herein below and the accompanying drawings, wherein like elements are represented by like reference numerals, which are by way of illustration only and thus do not limit the exemplary embodiments of the present invention and wherein:

FIG. 1 is a block diagram of an apparatus for discriminating a signal in accordance with an exemplary embodiment of the present invention.

FIG. 2 is a block diagram of an adaptive digital FIR filter in accordance with an exemplary embodiment of the present invention.

FIG. 3 is a flowchart for explaining a least mean square algorithm calculation in accordance with an exemplary embodiment of the present invention.

FIG. 4 is a block diagram of an apparatus for discriminating a signal in accordance with another exemplary embodiment of the present invention.

FIG. 5 is a detailed block diagram of a first adaptive digital FIR filter of FIG. 4.

FIG. 6 is a detailed block diagram of a second adaptive digital FIR filter of FIG. 4.

FIG. 7 is a diagram illustrating the generating of output signals using phase-shifted signals in accordance with the exemplary embodiments of the present invention.

### DETAILED DESCRIPTION OF THE EXEMPLARY EMBODIMENTS

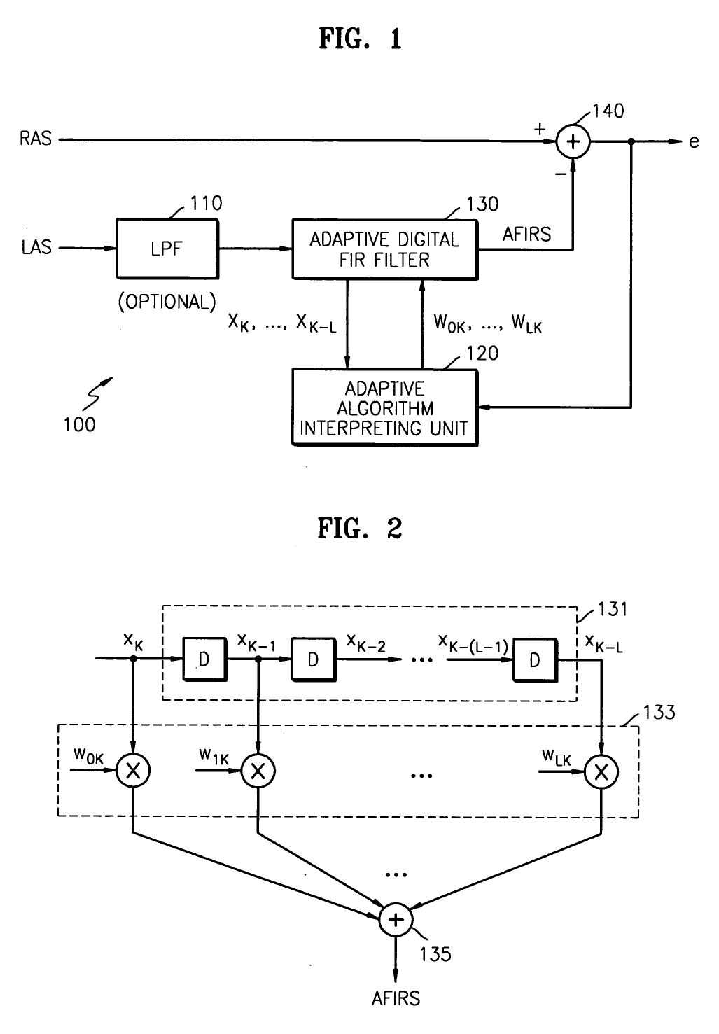

FIG. 1 is a block diagram of an apparatus for discriminating a signal in accordance with an exemplary embodiment of the present invention. Referring to FIG. 1, an apparatus 100 for discriminating a signal may receive input signals LAS and RAS and may include an optional low pass filter LPF 110 that performs low pass filtering of input signal LAS to output a first signal Xₖ. In an exemplary embodiment in which apparatus 100 does not include the low pass filter LPF 110, the input signal LAS corresponds to Xₖ. Input signals RAS and LAS may be stereo signals constituting an acoustic signal, i.e., an R channel signal (RAS) and an L channel signal (LAS).

The low pass filter LPF 110 blocks a high-frequency band signal, such as an accompaniment melody signal of the L channel signal LAS, for example, and performs low pass filtering on the L channel signal LAS to permit only a band below 4 kHz which a voice band exists in to pass therethrough. Each of the RAS and LAS is a two-channel stereo digital signal output from an audio system. Such an audio system may be embodied as a CD player, DVD player, audio cassette tape player, and FM audio broadcasting receiver, for example, although the exemplary embodiments may be applicable to any audio system configured to generate a two-channel stereo digital signal. The RAS and LAS may be used interchangeably.

Apparatus 100 may include an adaptive digital FIR filter 130. The adaptive digital FIR filter 130 receives first signal Xₖ and generates a plurality of delay signals Xₖ₋₁-X_{k-L} for output with the first signal Xₖ to an adaptive algorithm interpreting unit 120. The adaptive algorithm interpreting unit 120 receives the first signal Xₖ, the plurality of delay signals Xₖ₋₁-X_{k-L}, and an output signal ‘e’, and outputs a plurality of multiplication parameters W_{Ok}-W_{Lk}. The multiplication parameters may be calculated using an adaptive algorithm, for example, as to be further explained below.

Each of the plurality of delay signals Xₖ₋₁-X_{k-L}, may differ in time by one sample event, for example. The adaptive digital FIR filter 130 multiplies the first signal Xₖ and plurality of delay signals Xₖ₋₁-X_{k-L} by the plurality of corresponding multiplication parameters W_{Ok}-W_{Lk} in order to generate a removal-target signal AFIRS. The removal-target signal AFIRS is generated by summing the multiplied signals and is output to a subtracting unit 140.

The adaptive algorithm may be embodied as a least mean square (LMS) algorithm, for example, and may be designed for discriminating an original accompaniment melody signal component and a voice signal component (i.e., voice signal of a song or “song voice signal”) from a mixed acoustic signal. The mixed acoustic signal may be represented by the LAS and RAS received from different sources or sensors, for example. For purposes of clarity, the accompany melody signal component and song voice signal component of the mixed acoustic signal will be hereafter referred to as a ‘melody signal” and a ‘voice signal’.

The melody signal and voice signal may have different channel propagation characteristics. In general, to restore the original voice signal, the adaptive algorithm may be employed to interpret the mixed acoustic signal and to extract a removal-target signal AFIRS (such as the aforementioned voice signal) within a short convergence time. Preferably, the extracted voice signal has a high temporal correlation. In general, the melody signal has a lower temporal correlation between a previous signal and a current signal when compared with the voice signal, and each melody signal may be independently output. A more detailed description of the adaptive algorithm is presented below.

The subtracting unit 140 creates subtracts the removal-target signal AFIRS from the RAS to generate the output signal e. Since the output signal e is an estimate of the melody signal and includes no voice signal component, users hear only an accompaniment melody through a sound output device that may be operatively connected to apparatus 100, for example.

FIG. 2 is a block diagram of an adaptive digital FIR filter in accordance with an exemplary embodiment of the present invention. Referring to FIG. 2, the adaptive digital FIR filter 130 may include a delay unit 131. The delay unit 131 delays the received first signal Xₖ to generate the plurality of delay signals Xₖ₋₁-X_{k-L}, each of which may differ in time by one sample event, for example. Here, the first signal Xₖ may represent sample data that is continuously input at each sampling instant. The one sample event time difference may denote a time interval between samplings that are performed when an analog acoustic signal is digitalized. A simple logic circuit, such as a flip-flop (F/F) circuit, for example, may be used to generate the plurality of delay signals Xₖ₋₁-X_{k-L} by sequentially moving previous sample data. The flip-flop moves data at every clock cycle, for example.

The adaptive digital FIR filter 130 may include a multiplying unit 133. The multiplying unit 133 multiplies the first signal Xₖ and each of the plurality of delay signals Xₖ₋₁-X_{k-L} by a corresponding one of the multiplication parameters W_{Ok}-W_{Lk}, respectively to generate multiplied signals for output. The adaptive digital FIR filter 130 may be embodied as an “L+1” tap filter, for example, with the multiplying unit 133 including L+1 multipliers for multiplying the first signal Xₖ and the plurality of delay signals Xₖ₋₁-X_{k-L} by the plurality of multiplication parameters W_{Ok}-W_{Lk}, as shown in FIG. 2. The plurality of multiplied signals may be summed by an adding unit 135 so as to create or generate the removal-target signal AFIRS.

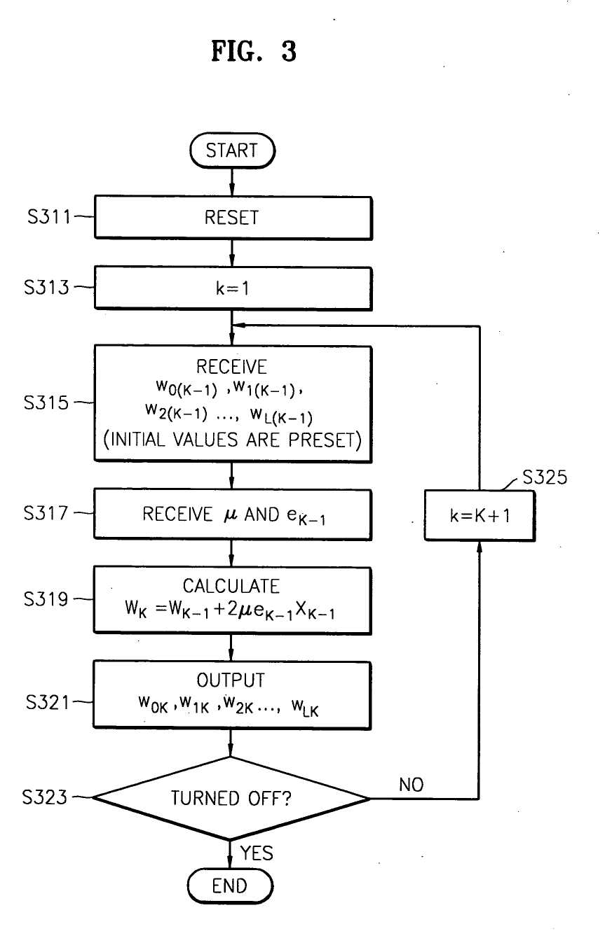

FIG. 3 is a flowchart for explaining a least mean square algorithm calculation in accordance with an exemplary embodiment of the present invention. In particular, FIG. 3 illustrates a least mean square algorithm calculation performed by the adaptive algorithm interpreting unit 120 to compute the multiplication parameters W_{Ok}-W_{Lk} that are output to the adaptive digital FIR filter 130.

The least mean square algorithm to determine a column matrix Wₖ of current multiplication parameters may be based on a linear function relationship shown in Equation 1:

Wₖ=Wₖ₋₁+2μeₖ₋₁X_{k-1′} (1)

In general, a column matrix X, composed of the input signal Xₖ and plurality of delay signals Xₖ₋₁-X_{k-L}, may be used with the output signal e to estimate the melody signal. Thus, Xₖ, Xₖ₋₁-X_{k-L}, and e may function as variables with respect to Equation 1. Wₖ represents a column matrix composed of current multiplication parameters, Wₖ₋₁ denotes a column matrix composed of the previous multiplication parameters, μ is a variable step size coefficient, eₖ₋₁ represents a digital value of the previous output signal, and Xₖ₋₁ denotes a column matrix composed of the input signal Xₖ and the plurality of delay signals Xₖ₋₁-X_{k-L}. The variable step size coefficient μ may be preset initially to a given value and subsequently adjusted in adaptive algorithm interpreting unit 120

Wₖ may be expressed as a column matrix composed of current multiplication parameters W_{Ok}-W_{Lk} as follows.

$$[ \begin{matrix}{W}_{0 k} \\ {W}_{1 k} \\ ⋮ \\ {W}_{L k}\end{matrix} ] \qquad ( 2 )$$

Similarly, Wₖ₋₁ may be expressed as a column matrix composed of previous multiplication parameters W_{O(k-1)}-W_{L(k-1)} as follows.

$$[ \begin{matrix}{W}_{0 ( k - 1 )} \\ {W}_{1 ( k - 1 )} \\ ⋮ \\ {W}_{L ( k - 1 )}\end{matrix} ] \qquad ( 3 )$$

Also, Xₖ₋₁ may be expressed as a column matrix composed of the input signal Xₖ and the plurality of delay signals Xₖ₋₁-X_{k-L}, each of which has a time difference by one sample event, as follows.

$$[ \begin{matrix}{X}_{k} \\ {X}_{k - 1} \\ ⋮ \\ {X}_{k - L}\end{matrix} ] \qquad ( 4 )$$

In Equation 1, the variable step size coefficient μ may influence convergence speed and stability after convergence. That is, if the variable step size coefficient μ is large, the convergence time is shortened whereas stability of the output signal e is degraded. The variable step size coefficients may be preset to a value suitable for the proper convergence time and stability after convergence in the adaptive algorithm interpreting unit 120.

Referring now to FIG. 3, for operation of the adaptive algorithm interpreting unit 120, the apparatus 100 is reset (function S311) when turned on or energized. Then, an initial state at the time of reset is recognized (for example, k=1) (function S313), and the plurality of multiplication parameters W_{Ok}-W_{Lk} preset to initial values are received (function S315). The adaptive algorithm interpreting unit 120 receives input signal Xₖ, plurality of delay signals Xₖ₋₁-X_{k-L} and eₖ₋₁ (function S317). The parameter eₖ₋₁ denotes the previous output signal. Once the adaptive algorithm interpreting unit 120 outputs current multiplication parameters W_{Ok}-W_{Lk}, the current output signal eₖ is output from the subtracting unit 140.

Thereafter, adaptive algorithm interpreting unit 120 calculates Wₖ (function S319) using Equation 1 and outputs the plurality of multiplication parameters W_{Ok}-W_{Lk} (function S321). A determination is then made as to whether the adaptive algorithm interpreting unit 120 has been turned off (function S323). If the adaptive algorithm interpreting unit 120 has not been turned off (output of S323 is ‘NO), steps S315 through S321 are repeated, until it is determined that the adaptive algorithm interpreting unit 120 has been turned off or de-energized (output of S323 is ‘YES’).

A convergence time (duration for which the multiplication parameters of adaptive algorithm are settled to its own stable and optimal value with minimum fluctuation) of the adaptive algorithm implemented as described above is substantially short. Thus, when the apparatus 100 is realized in various audio systems, where the output signal e, i.e., the estimated melody signal, is output through a sound output device such as a speaker, for example, users can hear, in almost real-time, accompaniment melodies having an improved quality.

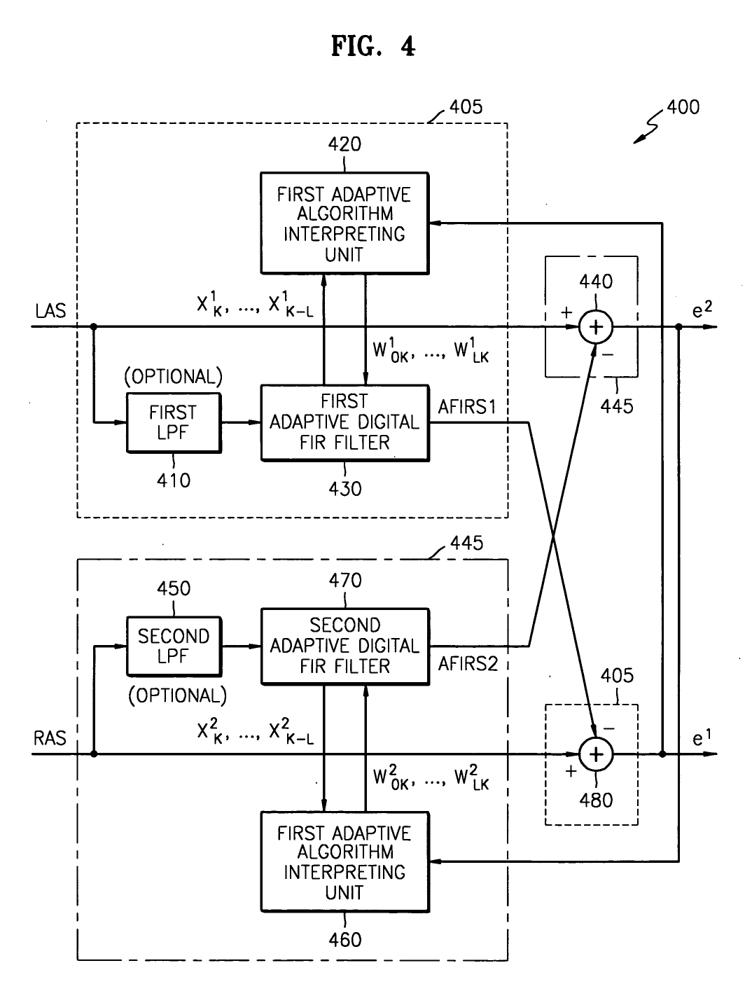

FIG. 4 is a block diagram of an apparatus for discriminating a signal in accordance with another exemplary embodiment of the present invention. FIG. 4 illustrates a signal discriminating apparatus 400 somewhat similar to FIG. 1, thus only the differences from FIG. 1 are primarily described with respect to FIG. 4 for the sake of brevity. In particular, apparatus 400 includes a first set or first arrangement 405 of components for processing the input signal LAS, and a second set or second arrangement 445 of components for processing the input signal RAS.

Referring to FIG. 4, an optional first low pass filter LPF 410 and an optional second low pass filter LPF 450 perform low pass filtering as described with respect to LPF 110 above, on one of input signals RAS and LAS and outputs a first signal X¹ₖ and a second signal X²ₖ, respectively. If the LPF 410 and LPF 450 are absent in apparatus 400, LAS represents the first signal X¹ₖ, and RAS is the second signal X²ₖ. The input signals RAS and LAS may be stereo signals as described previously with respect to FIG. 1.

in first arrangement 405, a first adaptive algorithm interpreting unit 420 receives a first signal X¹ₖ, a plurality of first delay signals X¹ₖ₋₁-X¹_{k-L}, and a first output signal e¹ and outputs a plurality of first multiplication parameters W¹_{Ok}-W¹_{Lk} that are calculated as described above with reference to FIG. 1 and FIG. 3. In other words, W¹ₖ, X¹ₖ, X¹ₖ₋₁-X¹_{k-L}, e¹, W¹_{Ok}-W¹_{Lk} correspond to the parameters Wₖ, Xₖ, Xₖ₋₁-X_{k-L}, e, W_{Ok}-W_{Lk}, previously described with reference to FIG. 3.

Similar to as was described with respect to FIG. 1, each of the plurality of delay signals X¹ₖ₋₁-X¹_{k-L} may differ in time by one sample event, for example. A adaptive digital FIR filter 430 thus multiplies the first signal X¹ₖ and plurality of delay signals X¹ₖ₋₁-X¹_{k-L} by the plurality of corresponding multiplication parameters W¹_{Ok}-W¹_{Lk} in order to generate a first removal-target signal AFIRS1. The first removal-target signal AFIRS1 is generated by summing the multiplied signals and is output to a first subtracting unit 480. The first subtracting unit 480 subtracts the first removal-target signal AFIRSI from the second signal X²ₖ and creates the first output signal e¹.

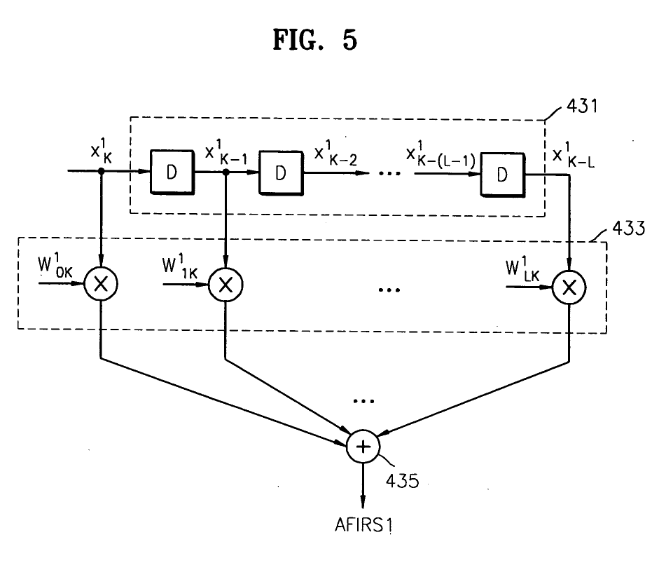

FIG. 5 is a block diagram of an adaptive digital FIR filter in accordance with an exemplary embodiment of the present invention. FIG. 5 is similar to FIG. 2, thus the functions described with respect to FIG. 5 have been explained in detail with respect to FIG. 2. In operation, a first delay unit 431 delays the received first signal X¹ₖ to generate the plurality of delay signals X¹ₖ₋₁-X¹_{k-L} that may differ in time by one sample event, where the first signal X¹ₖ may represent sample data that is continuously input at each sampling instant. A flip-flop (F/F) circuit, for example, may be used to generate the plurality of delay signals X¹ₖ₋₁-X¹_{k-L} by sequentially moving previous sample data. A first multiplying unit 433 multiplies the first signal X¹ₖ and plurality of delay signals X¹ₖ₋₁-X¹_{k-L} by a corresponding one of the multiplication parameters W¹_{Ok}-W¹_{Lk} to generate multiplied signals for output. The plurality of multiplied signals may be summed by adding unit 435 so as to create or generate the first removal-target signal AFIRS1.

Referring to FIG. 4, in second arrangement 445, a second adaptive algorithm interpreting unit 460 receives a second signal X²ₖ, a plurality of second delay signals X²ₖ₋₁-X²_{k-L}, and a second output signal e² to output second multiplication parameters W²_{Ok}-W²_{L} that are calculated as described above with reference to FIG. 1 and FIG. 3.

A second adaptive digital FIR filter 470 receives and delays the second signal X²ₖ, creates and outputs the plurality of second delay signals X²ₖ₋₁-X²_{k-L}, each of which has a time difference by one sample event, sums the results of multiplying the second signal X²ₖ and the plurality of second delay signals X²ₖ₋₁-X²_{k-L} by the plurality of second multiplication parameters W²_{Ok}-W²_{Lk}, and creates and outputs a second removal-target signal AFIRS2.

Similar to as was described with respect to FIG. 1, each of the plurality of delay signals X²ₖ₋₁-X²_{k-L} may differ in time by one sample event, for example. A adaptive digital FIR filter 470 thus multiplies the second signal X²ₖ and plurality of delay signals X²ₖ₋₁-X²_{k-L} by the plurality of corresponding multiplication parameters W²_{Ok}-W²_{Lk} in order to generate the second removal-target signal AFIRS2. The second removal-target signal AFIRS2 is generated by summing the multiplied signals and is output to a second subtracting unit 440. The second subtracting unit 440 creates the second output signal e² by subtracting the second removal-target signal AFIRS2 from the second signal X²ₖ.

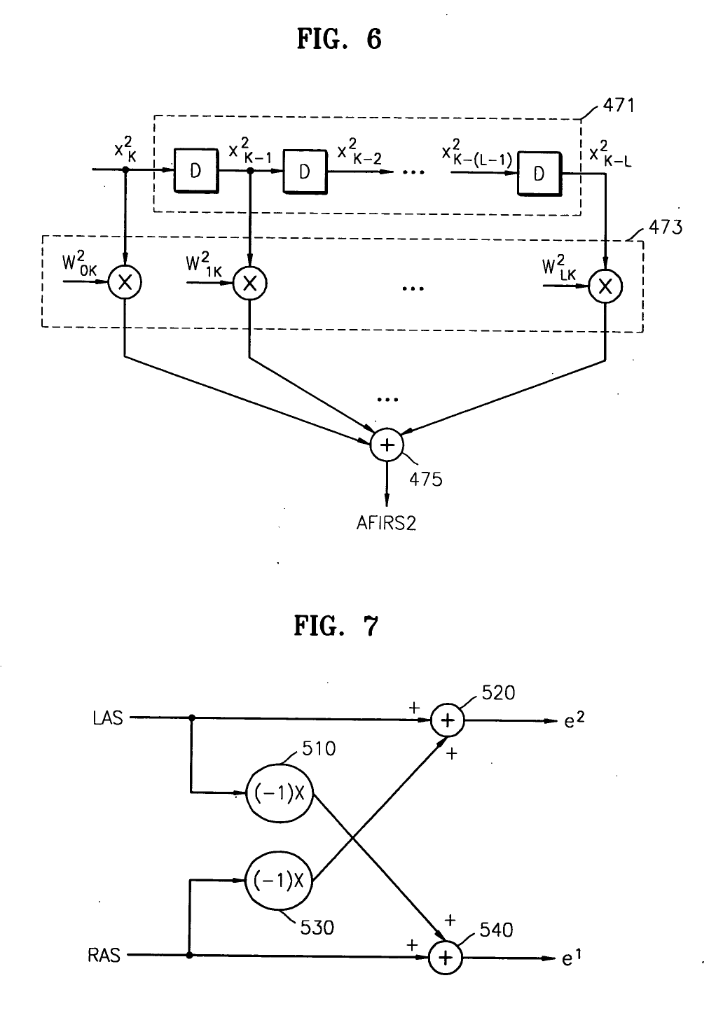

FIG. 6 is a block diagram of an adaptive digital FIR filter in accordance with an exemplary embodiment of the present invention. FIG. 6 is also similar to FIGS. 2 and 5. In operation, a second delay unit 471 delays the received second signal X²ₖ to generate the plurality of delay signals X²ₖ₋₁-X²_{k-L} that may differ in time by one sample event, where the second signal X²ₖ may represent sample data that is continuously input at each sampling instant. A flip-flop (F/F) circuit, for example, may be used to generate the plurality of delay signals X²ₖ₋₁-X²_{k-L} by sequentially moving previous sample data. A second multiplying unit 473 multiplies the second signal X²¹ₖ and plurality of delay signals X²ₖ₋₁-X²_{k-L} by multiplication parameters W²_{Ok}-W²_{Lk} to generate multiplied signals for output. The plurality of multiplied signals may be summed by second adding unit 475 so as to create or generate the second removal-target signal AFIRS2.

Since the first output signal e¹ output from the first subtracting unit 480 and the second output signal e² output from the second subtracting unit 440 are estimated as melody signals and do not include a voice signal, users hear only an accompanying melody through a speaker.

FIG. 7 is a diagram illustrating the generating of phase-inverted signals or 180 degree phase-shifted signals from the input signals, and generating of output signals using the phase-inverted/shifted signals in accordance with the exemplary embodiments of the present invention. Referring to FIG. 4, if the optional first low pass filter LPF 410 and optional second low pass filter LPF 450 are not included in a particular exemplary embodiment, the signal discriminating apparatus 400 may implement the same purpose when the first adaptive digital FIR filter 430 and second adaptive digital FIR filter 470 output the received first signal X¹ₖ and the received second signal X²ₖ to the first subtracting Unit 440 and the second subtracting unit 480, respectively.

This is the case illustrated in FIG. 7, where the first adaptive digital FIR filter 430 outputs first signal X¹ₖ as the first removal-target signal AFIRS1 and the second adaptive digital FIR filter 470 outputs the second signal X²ₖ as the second removal-target signal AFIRS2. To generate outputs, a first phase shifter 510 may be employed to shift phase of the first input signal LAS, and a second phase shifter 530 may be employed to shift phase of the second input signal RAS. Accordingly, a first adding unit 540 may sum the second input signal RAS and the output signal of the first phase shifter 510 to output the first output signal e¹, and a second adding unit 520 may sum the first input signal LAS and the output signal of the second phase shifter 530 to output the second output signal e². Since the first output signal e¹ and second output signal e² are free of a voice signal, only the estimated melody signals may be heard by users via a suitable sound output device such as a speaker.

According to the exemplary embodiments of the present invention, it is therefore possible to extract a removal-target signal (such as a voice or “song voice” signal) with a high temporal correlation within a short convergence time. The exemplary embodiments may employ a FIR filter that may operate based on interpretation results from a least mean square algorithm with respect to a first mixed signal and a second mixed signal, where each mixed signal may be composed of accompaniment melody signal components and song voice signal components that may have different channel propagation characteristics. As a result, users may be able to more easily select an accompaniment melody from their CD, DVD, audio cassette tape, or FM audio broadcasting device, in essentially real-time with improved quality for purposes of practice or entertainment, for example. Since the method described above is relatively simple and fast, it may be efficiently implemented in a digital signal processor (DSP) chip or micro-processor.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

What is claimed is:

1. An apparatus for discriminating a signal from at least one mixed signal having at least two signal components, comprising:
an interpreting unit generating a plurality of multiplication parameters based on a plurality of inputs that are related to a mixed signal;
a finite impulse response (FIR) filter outputting a removal-target signal based on the generated multiplication parameters; and
a subtracting unit generating an output signal representing one of the signal components of the at least one mixed signal by subtracting the removal-target signal from a second signal.

2. The apparatus of claim 1, wherein the plurality of inputs include a first signal, a plurality of delay signals based on the first signal, and a previous output signal.

3. The apparatus of claim 2, wherein the FIR filter generates the plurality of delay signals, which represent successive time delayed versions of the first signal, multiplies the first signal and plurality of delay signals by corresponding multiplication parameters to generate a plurality of multiplied signals, and sums the plurality of multiplied signals to generate the removal-target signal for output to the subtracting unit.

4. The apparatus of claim 2, further comprising a low pass filter which performs low pass filtering on an input signal to generate the first signal.

5. The apparatus of claim 2, wherein the FIR filter includes:
a delay unit which generates the plurality of delay signals, which represent successive time delayed versions of the first signal, each delay signal differing in time by one sample event;
a multiplying unit which multiplies the first signal and plurality of delay signals by corresponding multiplication parameters to generate a plurality of multiplied signals; and
an adding unit which sums the plurality of multiplied signals to generate the removal-target signal for output to the subtracting unit.

6. The apparatus of claim 2, wherein the interpreting unit calculates the plurality of multiplication parameters based on the relation:
Wₖ=Wₖ₋₁+2μeₖ₋₁Xₖ₋₁,
where Wₖ denotes a column matrix composed of current multiplication parameters, Wₖ₋₁ denotes a column matrix composed of previous multiplication parameters, μ denotes a variable step size coefficient, eₖ₋₁ denotes a digital value of the previous output signal, and Xₖ₋₁ denotes a column matrix composed of the input signal and the plurality of delay signals, each delay signal differing in time by one sample event.

7. The apparatus of claim 2, wherein the first signal and second signal are mixed signals.

8. The apparatus of claim 2, wherein the first signal and second signal are stereo two-channel digital signals output from an audio system selected from a group consisting of a compact disc player, a digital video disc player, an audio cassette tape player, and a FM audio broadcasting receiver.

9. An apparatus for discriminating a signal from at least one mixed signal having at least two signal components, comprising:
a first arrangement generating a plurality of first multiplication parameters based on a plurality of first inputs including a first signal that are related to a mixed signal, outputting a first removal-target signal based on the generated first multiplication parameters, and generating a first output signal representing one of the signal components of the at least one mixed signal based on the first removal-target signal and a second signal; and
a second arrangement generating a plurality of second multiplication parameters based on a plurality of second inputs including the second signal that are related to a mixed signal, outputting a second removal-target signal based on the generated second multiplication parameters, and generating a second output signal representing one of the signal components of the at least one mixed signal based on the second removal-target signal and the first signal.

10. The apparatus of claim 9,
wherein the first arrangement includes:
a first interpreting unit generating the plurality of first multiplication parameters based on the plurality of first inputs;
a first finite impulse response (FIR) filter generating the first removal-target signal based on the first multiplication parameters; and
a first subtracting unit generating the first output signal by subtracting the first removal-target signal from the second signal; and
wherein the second arrangement includes:
a second interpreting unit generating the plurality of second multiplication parameters based on the plurality of second inputs;
a second finite impulse response (FIR) filter generating the second removal-target signal based on the second multiplication parameters; and
a second subtracting unit generating the second output signal by subtracting the second removal-target signal from the first signal.

11. The apparatus of claim 9, wherein
the plurality of first inputs additionally includes a plurality of first delay signals based on the first signal and a previous first output signal, and
the plurality of second inputs additionally includes a plurality of second delay signals based on the second signal and a previous second output signal.

12. The apparatus of claim 11, wherein
the first FIR filter generates the plurality of first delay signals, which represent successive time delayed versions of the first signal, multiplies the first signal and plurality of first delay signals by corresponding first multiplication parameters to generate a plurality of first multiplied signals, and sums the plurality of first multiplied signals to generate the first removal-target signal for output to the first subtracting unit, and
the second FIR filter generates the plurality of second delay signals, which represent successive time delayed versions of the second signal, multiplies the second signal and plurality of second delay signals by corresponding second multiplication parameters to generate a plurality of second multiplied signals, and sums the plurality of second multiplied signals to generate the second removal-target signal for output to the second subtracting unit.

13. The apparatus of claim 9, wherein
the first arrangement further includes a first low pass filter which performs low pass filtering on a first input signal to generate the first signal, and
the second arrangement further includes a second low pass filter which performs low pass filtering on a second input signal to generate the second signal.

14. The apparatus of claim 11, wherein the first FIR filter includes:
a first delay unit which generates the plurality of first delay signals, which represent successive time delayed versions of the first signal, each first delay signal differing in time by one sample event;
a first multiplying unit which multiplies the first signal and plurality of first delay signals by corresponding first multiplication parameters to generate a plurality of first multiplied signals; and
a first adding unit which sums the plurality of first multiplied signals to generate the first removal-target signal for output to the first subtracting unit.

15. The apparatus of claim 11, wherein the second FIR filter includes:
a second delay unit which generates the plurality of second delay signals, which represent successive time delayed versions of the second signal, each second delay signal differing in time by one sample event;
a second multiplying unit which multiplies the second signal and plurality of second delay signals by corresponding second multiplication parameters to generate a plurality of second multiplied signals; and
a second adding unit which sums the plurality of second multiplied signals to generate the second removal-target signal for output to the second subtracting unit.

16. The apparatus of claim 10, wherein either or both of the first or second interpreting units calculate corresponding first or second multiplication parameters based on the relation:
Wₖ=Wₖ₋₁+2μeₖ₋₁Xₖ₋₁,
where Wₖ denotes a column matrix composed of current multiplication parameters, Wₖ₋₁ denotes a column matrix composed of previous multiplication parameters, μ denotes a variable step size coefficient, eₖ₋₁ denotes a digital value of the previous output signal, and Xₖ₋₁ denotes a column matrix composed of the input signal and the plurality of delay signals, each delay signal differing in time by one sample event.

17. The apparatus of claim 9, wherein the first and second signals are mixed signals.

18. The apparatus of claim 9, wherein the first signal and second signal are stereo two-channel digital signals output from an audio system selected from a group consisting of a compact disc player, a digital video disc player, an audio cassette tape player, and a FM audio broadcasting receiver.

19. A method of discriminating a signal from at least one mixed signal having at least two signal components, comprising:
generating a plurality of multiplication parameters based on a plurality of inputs that are related to a mixed signal;
outputting a removal-target signal based on the generated multiplication parameters; and
generating an output signal representing one of the signal components of the at least one mixed signal by subtracting the removal-target signal from a second signal.

20. The method of claim 19, wherein the plurality of inputs include a first signal, a plurality of delay signals based on the first signal, and a previous output signal.

21. The method of claim 20, further comprising performing low pass filtering on an input signal to output the first signal.

22. The method of claim 20, wherein the outputting step is part of a digital filtering step, the digital filtering step further including:
delaying the first signal to generate the plurality of delay signals which represent successive time delayed versions of the first signal, each delay signal differing in time by one sample event;
multiplying the first signal and the plurality of delay signals by corresponding multiplication parameters to generate a plurality of multiplied signals; and
summing the multiplied signals to generate the removal-target signal.

23. The method of claim 19, wherein the generating a plurality of multiplication parameters step further includes calculating the plurality of multiplication parameters based on the following relation:
Wₖ=Wₖ₋₁+2μeₖ₋₁Xₖ₋₁,
where Wₖ denotes a column matrix composed of current multiplication parameters, Wₖ₋₁ denotes a column matrix composed of previous multiplication parameters, μ denotes a variable step size coefficient, eₖ₋₁ denotes a digital value of the previous output signal, and Xₖ₋₁ denotes a column matrix composed of the input signal and the plurality of delay signals, each delay signal differing in time by one sample event.

24. The method of claim 20, wherein the first signal and second signal are adapted so as to be interchangeably used.

25. A method for discriminating a melody signal from at least one acoustic signal composed of at least a melody signal component and a voice signal component, comprising:
first low pass filtering an input first acoustic signal to output a first signal;
first calculating a plurality of first multiplication parameters based on the first signal, a plurality of first delay signals, and a first output signal;
first filtering to generate the plurality of first delay signals, the first filtering including multiplying the first signal and plurality of first delay signals by corresponding first multiplication parameters to generate a first set of multiplied signals, and summing the first set of multiplied signals to generate a first removal-target signal;
first subtracting the first removal-target signal from a second acoustic signal to generate a first output signal that is an estimate of a melody signal component of the first acoustic signal;
second low pass filtering the second acoustic signal to output a second signal;
second calculating a plurality of second multiplication parameters based on the second signal, a plurality of second delay signals, and a second output signal;
second filtering to generate the plurality of second delay signals, the second filtering step including multiplying the second signal and plurality of second delay signals by corresponding second multiplication parameters, a second set of multiplied signals, and summing the second set of multiplied signals to generate a second removal-target signal; and
second subtracting the second removal-target signal from the first signal to generate a second output signal that is an estimate of a melody signal component of the second acoustic signal.

26. An apparatus for discriminating a melody signal from at least one acoustic signal composed of at least a melody signal component and a voice signal component in accordance with the method of claim 25.

27. An apparatus for discriminating a signal from at least one mixed signal having at least two signal components in accordance with the method of claim 25.
